(19) United States
(12) Patent Application Publication
(10) Pub. No.: US 2006/0204938 A1
(43) Pub. Date: Sep. 14, 2006

(54) System for modifying child behavior

(76) Inventor: Robert Field, Alamo, CA (US)

Correspondence Address: MCDERMOTT WILL & EMERY LLP, 600 13TH STREET, N.W., WASHINGTON, DC, 20005-3096, US

(21) Appl. No.: 11/334,732

(22) Filed: Jan. 19, 2006

Related U.S. Application Data
(60) Provisional application No. 60/644,529, filed on Jan. 19, 2005.

(51) Int. Cl. G09B 19/00

(52) U.S. Cl. 434/238

(57) ABSTRACT

The system assesses problem behaviors and identifies those behaviors to be targeted through the use of an interview process that generates a behavior rating report. Through a parenting style interview, the system provides parents with issues that may influence their parenting skills, and helps the parents discover the strengths and weaknesses of their particular parenting style. A unique plan for each child is then developed to minimize problem behavior by changing the parents' response to the behaviors. This teaches the child that good decisions lead to positive consequences and higher self-esteem. A behavior chart is created and used to track the child's problem behavior. After a period of time, one week, the parent returns to develop a consequence system to improve behavior of the child. The child's baseline behavior is calculated, which will be used to measure progress. Specific consequences are determined that will be used to motivate the child to change his or her behavior. The child's baseline behavior can then be recalculated.

### TECHNICAL FIELD

The disclosure relates generally to child psychology and, more specifically, to an internet-based system for modifying child behavior.

### BACKGROUND ART

Children may be afflicted by many types of psychological disorders. For example, Attention Deficit Hyperactivity Disorder (ADHD) is characterized with symptoms that include inattention, impulsivity, hyperactivity, disorganization and learning problems. A problem with ADHD is that there is no definite method of assessment for a clear diagnosis of this disorder. Another disorder is Asperger's Syndrome, which is a complex disorder of attention, interpersonal relationships and cognitive problems that lay on the continuum between ADHD and Autism. Oppositional Defiant Disorder (ODD) is a diagnosis based on the existence of behavioral problems. ODD defines challenge to authority, refusal to cooperate and episodes of angry outbursts as a syndrome. Consistent refusal to cooperate, difficulty in managing day-to-day expectations such as getting dressed, brushing teeth and hair and following directions can all indicate ODD.

Another type of problem is generally reflected by poor peer relationships. Interactions with peers are very complex and require many different abilities. A child should have the ability to correctly observe others and find methods to interact with the styles of other children. As a child gets older, the social demands become greater, and the child with better social skills develops a sense of how to cope to fit in. Every child is challenged, and a particular child's problem solving method may succeed or fail. The way a child handles the failure is critical. If a child is unsuccessful in coping with the social pressures, the child may withdraw due to low self-esteem and subsequently be at high risk for problem behavior.

Although many of these types of disorders may be treatable, the disorder must first be diagnosed by a healthcare professional, such as a psychiatrist, psychologist, behavioral specialist or therapist, after which a particular type of treatment may be prescribed. If the treatment includes behavior modification, the parents of the child may have to be intimately involved with the administration of the behavior modification and observing the results thereof. The parents' actions, however, should be coordinated and directed by the healthcare professional prescribing the treatment.

One drawback with the model of treatment is that the constant interaction between parents and the healthcare professional observation may be expensive. Furthermore, situations exist in which feedback is needed, which cannot always be provided by the healthcare processional. There is, therefore, a need for an individualized system that will allow a parent to analyze and improve a child's behavior that does not require the interaction of a healthcare professional.

### SUMMARY OF THE DISCLOSURE

In one aspect, an internet based system and method for facilitating child behavior modification is provided. The system assesses problem behaviors and identifies those behaviors to be targeted through the use of an interview process that generates a behavior rating report. Through a parenting style interview, the system provides parents with issues that may influence their parenting skills, and helps the parents discover the strengths and weaknesses of their particular parenting style. A unique plan for each child is then developed to minimize problem behavior by changing the parents' response to the behaviors. This teaches the child that good decisions lead to positive consequences and higher self-esteem. A behavior chart is created and used to track the child's problem behavior. After a period of time, one week, the parent returns to the website to develop a consequence system to improve behavior of the child. The child's baseline behavior is calculated, which will be used to measure progress. Specific consequences are determined that will be used to motivate the child to change his or her behavior. The child's baseline behavior can then be recalculated.

Other aspects and advantages of the present disclosure will become apparent to those skilled in this art from the following description of preferred aspects taken in conjunction with the accompanying drawings. As will be realized, the disclosed concepts are capable of other and different embodiments, and its details are capable of modifications in various obvious respects, all without departing from the spirit thereof. Accordingly, the drawings, disclosed aspects, and description are to be regarded as illustrative in nature, and not as restrictive.

### BRIEF DESCRIPTION OF THE DRAWINGS

The foregoing and other features, aspects and advantages of the present concepts are described in the following detailed description which examples are supplemented by the accompanying drawings, in which:

FIG. 1A, 1B are block diagrams showing the internet-based child behavior modification system, according to the disclosure;

FIG. 2 is a block diagram illustrating the step of assessing problem behavior;

FIG. 3 is a block diagram illustrating the step of understanding parenting style;

FIG. 4 is a block diagram illustrating the step of developing a unique plan;

FIG. 5 is a block diagram illustrating the step of setting up a behavior chart;

FIG. 6 is a block diagram illustrating the step of calculating baseline behavior;

FIG. 7 is a block diagram illustrating the step of determining the consequences for the behavior; and

FIG. 8 is a block diagram illustrating the step of guidelines for directive parenting.

### DETAILED DESCRIPTION OF THE PREFERRED EMBODIMENTS

The present system involves a systematic behavioral approach that relies on placing responsibility for behavior on the child and requires the parent to administer the appropriate consequence. Through this system, the child is not punished, but instead, control important aspects of his or her life by his or her behavior. This model works through childhood and then can be modified for use with adolescence.

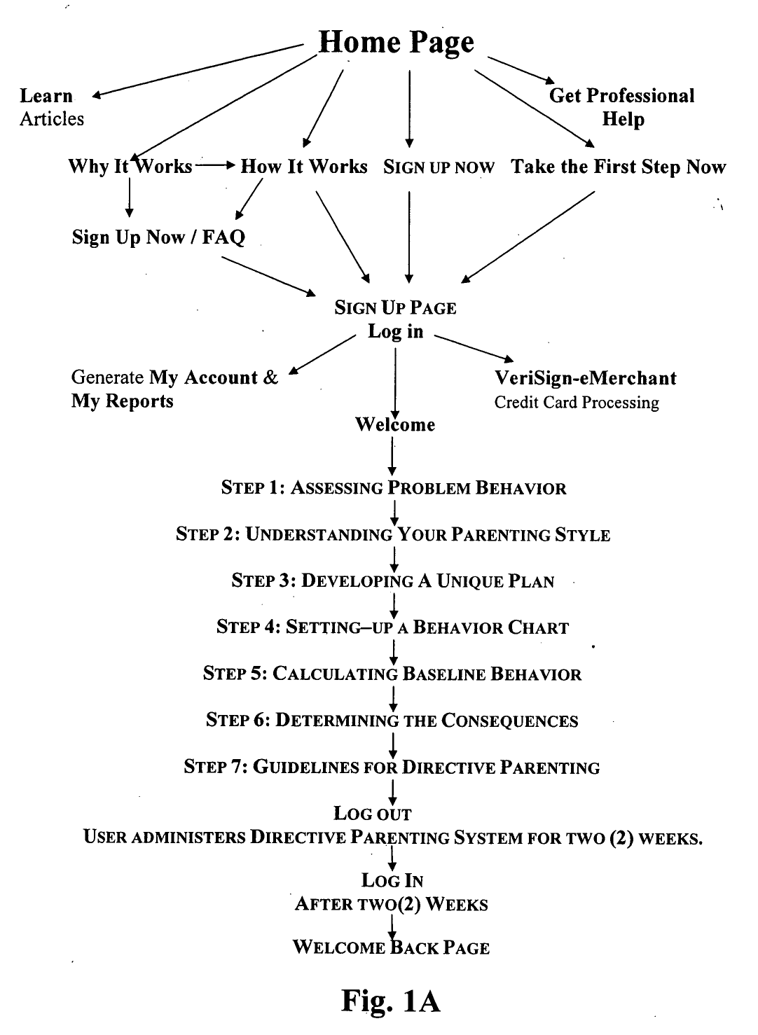

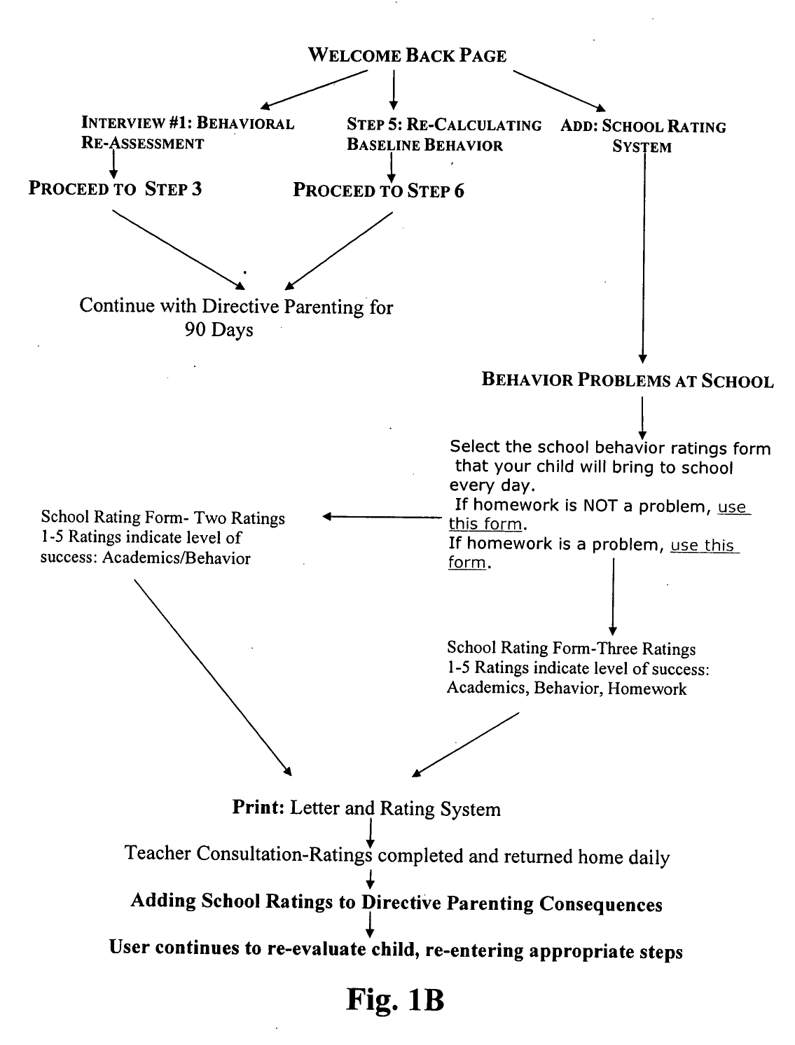

An overview of the system and program is illustrated in FIGS. 1A, 1B. Specifically, the system involves providing a website that has a complete behavioral plan that does not require personal consultation with a behavioral specialist or therapist. Through a step-by-step process, behavior problems are ranked by severity and frequency; parenting style is evaluated; child behavior is observed; and consequences are developed.

In general, the client may only access the system upon signup and/or login. In addition, the client is directed to logout to ensure confidentiality, and the system logs out automatically after 20 minutes of inactivity (i.e., session timeout). The program is intended to be completed sequentially. Checkmarks are placed in the left “Step Navigation” when each section is completed, and it is possible to return to the previous sections by clicking on the left navigation links.

Part 1 of the program (steps 1-4) must be completed before the client/parent gains access to Part 2 (steps 5-7). They must logout after completing Step 4 and login to begin Step 5 (one week later). The client can view their completed surveys and forms by clicking on the “My Reports” link once they're within the restricted area. The Reports include: 1) Behavior Assessment; 2) Parenting Style; 3) Baseline Behavior; 4) Additional reports based on scores of reports above; 5) Bedtime Chart; and 6) Computer/TV Chart.

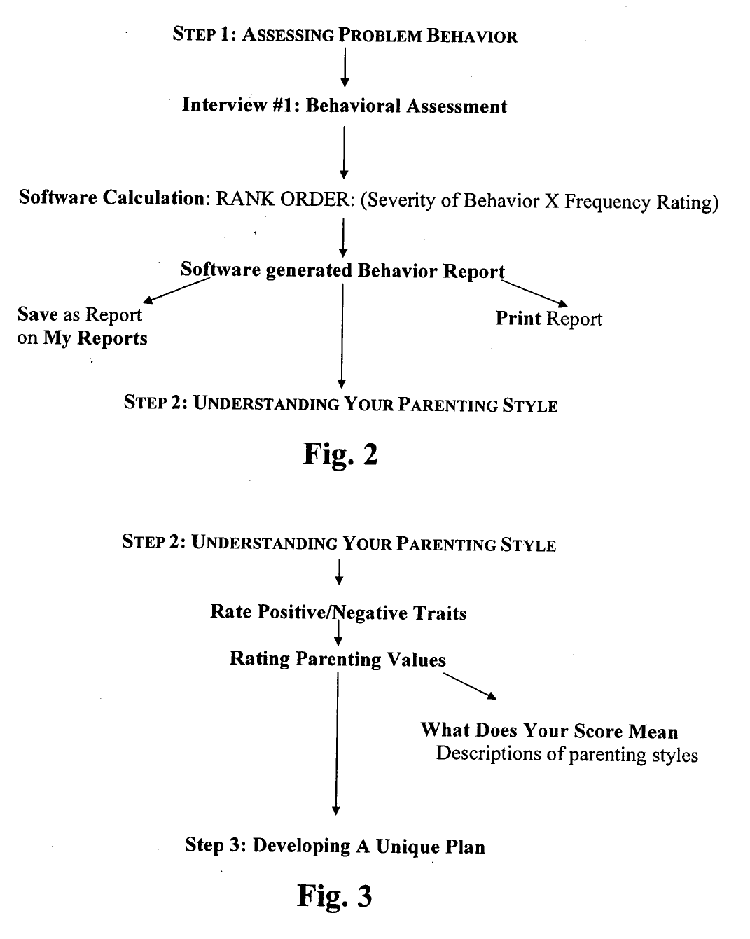

Step 1 is illustrated in FIG. 2. After logging onto the website, the parents are directed to indicate the frequency of the behavior problems of the child that the parents experience. Based on the parents' ratings and the severity of the symptom, the parents receive a report indicating what behaviors should first be addressed. Also, if the parents' observation and rankings are consistent with symptoms of ADHD or anxiety, the website provides a message in the report addressing these particular concerns and provides a recommendation that the child may need referral to a specialist. Also, after the symptoms and frequencies of symptoms are scored, if the score for the overall symptoms exceeds a predetermined value, a message in the report is generated indicating that a referral may be necessary.

Step 2 is illustrated in FIG. 3. Since the behavior of a parent has a significant impact on the child's behavior, a survey is taken to identify a particular parenting style of the parent. After the parents answer certain questions, the parents receive a report of how their parenting style affects the child's behavior. During the complete process, the parents are reminded of the importance of objectivity, consistency and the lack of emotionality.

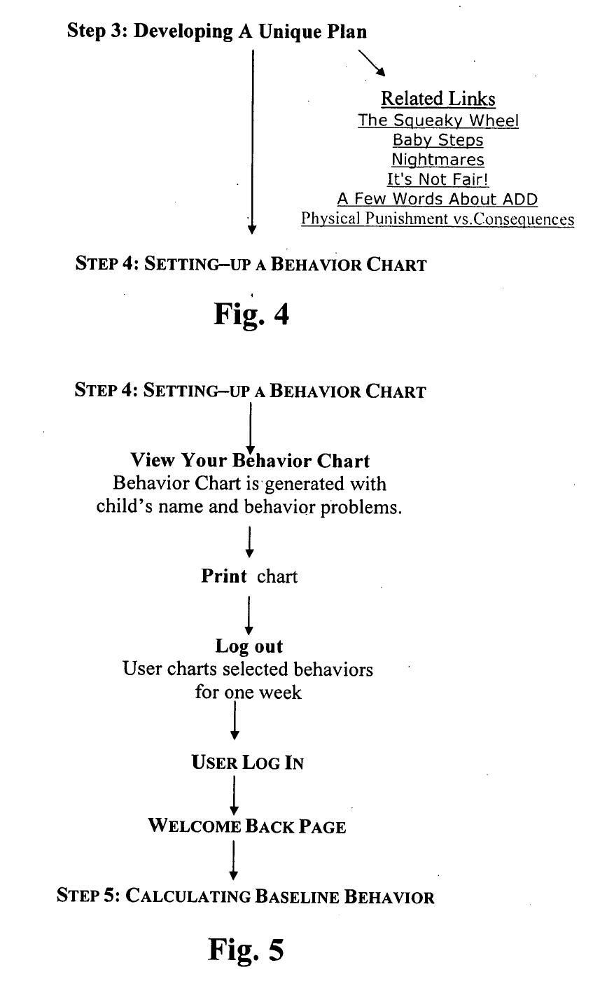

Steps 3 and 4 and respectively illustrated in FIGS. 4 and 5. These steps present important information about behavioral approaches to the parents and lead the parents in generating a behavior chart. Based upon the parents' input from the behavioral interview, the five most significant behavioral problems are already listed with the child's name. The parents are then able to print this chart and log off the system to track these behavior problems for one week. The charting enables the parents to become more objective and less emotional about the child's behavior, which greatly improvestheir chances for success.

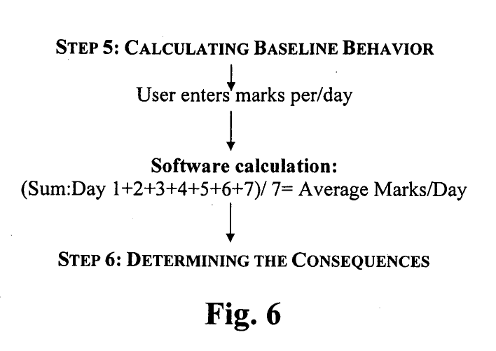

Step 5 is illustrated in FIG. 6. After approximately one week, the parents logon to the system and directed to Part 2 of the system, developing consequences for behavior.

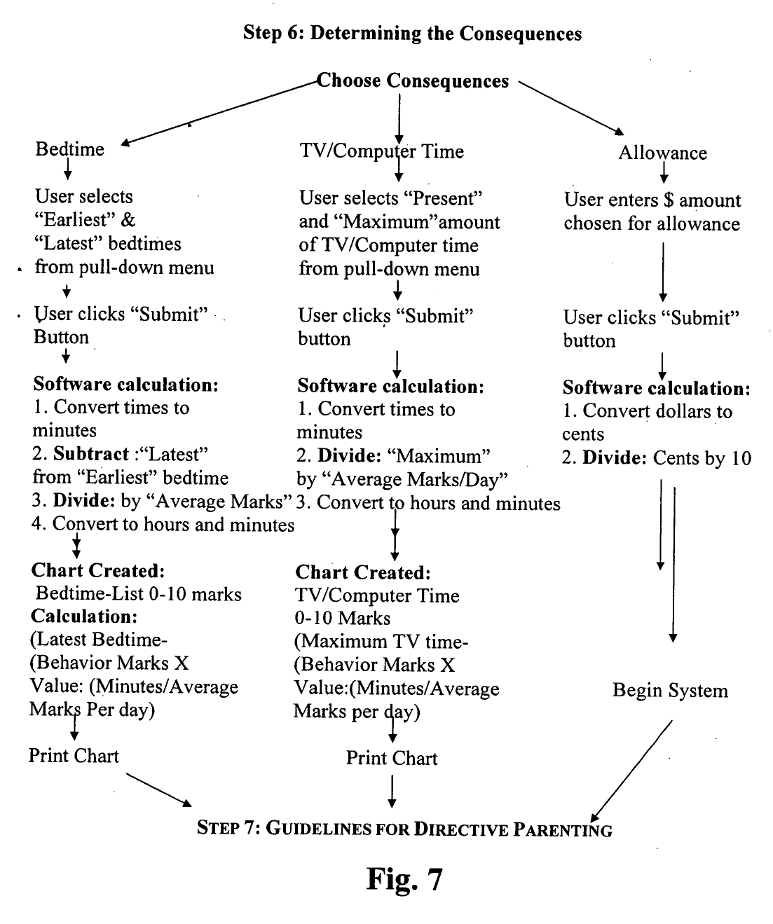

Step 6 is illustrated in FIG. 7. After entering the amount of behaviors observed each day, the parents are asked to choose one of three consequence systems available.

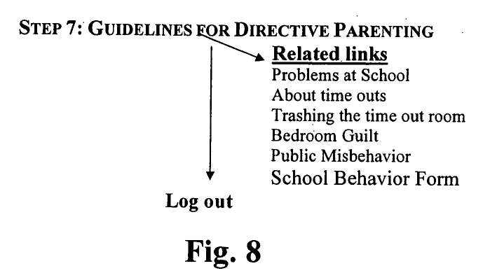

Step 7 is illustrated in FIG. 8. The system then calculates a value of each behavior mark. More behavior marks equate into less privileges for the child. The parents then use this system for a week and can return as many times as they wish for a 90 day period. As behavior problems diminish, parents may return to the first interview to reevaluate what behaviors are of greatest concern based on the improvement observed.

The embodiments described herein may be used with any conventional methodology and equipment. Accordingly, the details of such equipment and methodology are not set forth herein in detail. Various aspects of the present concepts have been discussed in the present disclosure for illustrative purposes. It is to be understood that the concepts disclosed herein is capable of use in various other combinations and environments and is capable of changes or modifications within the scope of the concepts expressed herein.

I claim:

1. An internet based system for facilitating child behavior modification, comprising:
an apparatus for accessing a web-site, wherein said web-site includes an interactive program that generates a behavior report in response to a user interview in which the user is queried regarding a plurality of behaviors and responds with an indication of the frequency of the queried behaviors.

2. The internet based system according to claim 1, wherein the behavior report indicates, on a priority basis, the behavior patterns to be addressed based on the frequency of said behavior and severity of any associated problem.

3. The internet based system according to claim 1, wherein the web-site includes a program for conducting a survey to identify the parenting style of the user, and generating a report indicating how the parenting style affects the behavior.

4. The internet based system according to claim 1, wherein the web-site includes a program for presenting behavioral approaches to the user and generating a behavioral chart based on user input to the behavioral approaches.

5. The internet based system according to claim 1, wherein the web-site includes a program for developing consequences for the behavior.

6. The internet based system according to claim 1, wherein the web-site includes a program for asking the user to select a consequence system regarding indicated behaviors.

7. The internet based system according to claim 6, wherein said consequence system is based on the frequency of the observed behaviors.

8. The internet based system according to claim 6, wherein the web-site includes a program for calculating a value for each behavior, and for selecting a consequence from a consequence system based on said value.

9. An interactive method for remotely facilitating child behavior modification, comprising the steps of:
providing at the patient's location an indication of the frequency of occurring behaviors; and
generating, at a system located remote from the patient, a behavior report in response to the indicated frequency of the behaviors.

10. The method according to claim 9, wherein the behavior report indicates, on a priority basis, those behaviors to be addressed based on the indicated frequency of the behaviors and the severity of the behavior.

11. The method according to claim 9, further comprising the steps of:
conducting a survey to identify the parenting style of a user; and
generating a report indicating how the parenting style affects particular behaviors.

12. The method according to claim 9, further comprising the steps of:
presenting behavioral approaches to a user; and
generating a behavioral chart based on user input to the behavioral approaches.

13. The method according to claim 9, further comprising the step of:
developing consequences for various behaviors.

14. The method according to claim 9, further comprising the step of:
selecting a consequence system based on the frequency of observed behaviors.

15. The method according to claim 14, further comprising the steps of:
calculating a value for each of a plurality of behaviors; and
selecting a consequence from the consequence system based on said value.
